(19) United States
(12) Patent Application Publication
(10) Pub. No.: US 2016/0281629 A1
(43) Pub. Date: Sep. 29, 2016

(54) CONTROL DEVICE FOR FUEL INJECTION VALVE

(71) Applicant: KEIHIN CORPORATION, Tokyo (JP)

(72) Inventors: Masateru Moriya, Sakura-shi (JP); Gaku Sato, Utsunomiya-shi (JP); Junichi Miyashita, Utsunomiya-shi (JP); Kousaku Yotoriyama, Utsunomiya-shi (JP)

(21) Appl. No.: 15/077,145

(22) Filed: Mar. 22, 2016

(30) Foreign Application Priority Data
Mar. 24, 2015 (JP) 2015-060441

(51) Int. Cl. F02D 41/24

(52) U.S. Cl. CPC F02D 41/2467; F02D 41/2441

(57) ABSTRACT

A control device includes a difference calculating unit configured to generate a difference waveform composed of the difference between a normal operation waveform, which is a voltage waveform of the fuel injection valve at a time that the fuel injection valve is operating, and a non-operation waveform, which is a voltage waveform of the fuel injection valve at a time that the fuel injection valve is not operating, a derivative calculating unit configured to generate a differentiated waveform obtained by differentiating the difference waveform, and an operating state determining unit configured to determine the operating state of the fuel injection valve based on the differentiated waveform.

### CROSS-REFERENCE TO RELATED APPLICATION

This application is based upon and claims the benefit of priority from Japanese Patent Application No. 2015-060441 filed on Mar. 24, 2015, the contents of which are incorporated herein by reference.

### BACKGROUND OF THE INVENTION

1. Field of the Invention

The present invention relates to a control device for a fuel injection valve that determines an operating state of the fuel injection valve, and controls the fuel injection valve based on a determination result thereof.

2. Description of the Related Art

For example, in Japanese Laid-Open Patent Publication No. 2001-280189, it is disclosed that, in order for an injection amount of a fuel injection valve to be maintained for an initial set time, valve-open and valve-closed displacement points are detected based on a temporal change of a current that flows through the coil of a fuel injection valve. Further, based on the detected displacement points, a fluctuation of a delay time of the valve-open and valve-closed states is detected based on the detected displacement points, and a pulse width of an applied pulse, which is applied with respect to the coil, is corrected by the detected amount of fluctuation.

### SUMMARY OF THE INVENTION

In this manner, it is known from the conventional art that the operational state of a fuel injection valve can be determined from a temporal change in the current.

On the other hand, recently, there has been a demand to improve the injection performance of a fuel injection valve, and for this purpose, there is a requirement to control the fuel injection valve with high precision.

According to Japanese Laid-Open Patent Publication No. 2001-280189, when a movable core and a valve body of the fuel injection valve are moved at a time of valve-opening, and the valve body collides against a valve seat, an inductance in the magnetic path undergoes a change in a different manner than before, and a displacement point (inflection point) is generated in the current that flows through the coil. Thus, by detecting the inflection point, a time delay of the valve-closing operation (an operating state of the fuel injection valve) is detected.

The inflection point appears conspicuously as the change in velocity of the movable core and the valve body becomes large at the time of valve-closing, and the temporal change in the inductance becomes large. More specifically, in the case that the movable core and the valve body are constructed integrally, since the velocity change at the time of valve-closing is large, the temporal change in the inductance also becomes large, and the inflection point can be detected easily.

In contrast thereto, in the case that the temporal change of the inductance during valve-closing is small, it becomes difficult to detect the inflection point, and a difficulty occurs in that the operating state of the fuel injection valve cannot be determined. More specifically, in the event that the movable core and the valve body are constructed separately, and the movable core and the valve body do not move integrally at the time of valve-closing, even if the valve body becomes seated on the valve seat and the fuel injection valve is placed in a valve-closed state, the movable core continues to move. Consequently, the speed change is not increased and the temporal change in the inductance is small, so that detection of the displacement point becomes difficult.

Accordingly, it may be difficult to detect the inflection point simply by differentiating the current waveform, as proposed in Japanese Laid-Open Patent Publication No. 2001-280189.

Further, if changes occur in the situations of the fuel injection valves due to structural differences of individual fuel injection valves, variances in the capabilities of response, durability and deterioration, etc., of the individual fuel injection valves, and changes in the surrounding environment such as pressure and atmospheric temperature, etc., of the fuel supplied to the fuel injection valves, there is a concern that determination of the operating states of the fuel injection valves may become even more difficult.

In this manner, by the determination of the operating state of the fuel injection valve becoming more difficult, it becomes impossible to carry out an appropriate control with respect to the fuel injection valve, leading to a concern that the injection capability of the fuel injection valve will deteriorate. For example, due to changes over time or aging of the fuel injection valve, even in the case of a time delay occurring in the valve-closing operation, if it is difficult to detect the inflection point that is intended to be detected, a variance occurs in the control of the fuel injection valve, and the injection performance of the fuel injection valve is lowered.

The present invention has been devised while taking into consideration the aforementioned problems, and has the object of providing a control device for a fuel injection valve that enables the operating state of the fuel injection valve to be determined with high accuracy in various circumstances.

The present invention relates to a control device for a fuel injection valve that determines an operating state of the fuel injection valve, and controls the fuel injection valve based on a determination result thereof.

In addition, for accomplishing the aforementioned object, the control device for a fuel injection valve according to the present invention includes a difference calculating unit, a derivative calculating unit, and an operating state determining unit.

The difference calculating unit generates a difference waveform composed of the difference between a normal operation waveform, which is a voltage waveform of the fuel injection valve at a time that the fuel injection valve is operating, and a non-operation waveform, which is a voltage waveform of the fuel injection valve at a time that the fuel injection valve is not operating.

The derivative calculating unit generates a differentiated waveform obtained by differentiating the difference waveform.

The operating state determining unit determines the operating state of the fuel injection valve based on the differentiated waveform.

According to the present invention, after the difference waveform has been generated by calculating the difference between the normal operation waveform and the non-operation waveform, the differentiated waveform is generated by differentiating the difference waveform, and the operating state of the fuel injection valve is determined from the differentiated waveform that was generated. More specifically, with the present invention, the differentiated waveform is generated by differentiating the difference waveform, and without simply differentiating the normal operation waveform as in Japanese Laid-Open Patent Publication No. 2001-280189.

Consequently, even if a temporal change of the inductance at the time of valve-closing is small, and it is difficult to detect an inflection point from the normal operation waveform, by using the differentiated waveform obtained from the difference waveform, the inflection point of the normal operation waveform can be detected. As a result, even if various different situations of the fuel injection valve are present, since it is possible to confirm the inflection point accurately, the operating state of the fuel injection valve can be determined with high reliability. Therefore, with the present invention, based on the highly precise determination result, the fuel injection valve can be controlled appropriately, and the injection performance of the fuel injection valve can be enhanced.

In the present invention, to explain in greater detail, the phrase, “at a time that the fuel injection valve is operating” refers to a case in which, due to energizing the coil of the fuel injection valve, the valve body is placed in a valve-open or a valve-closed condition, whereby the fuel injection valve carries out its inherent operation (i.e., an operation to inject fuel). Consequently, the phrase, “normal operation waveform, which is a voltage waveform of the fuel injection valve at a time that the fuel injection valve is operating” implies a voltage waveform that is generated in the coil when the fuel injection valve is operated by supplying current to the coil of the fuel injection valve.

Further, the phrase, “at a time that the fuel injection valve is not operating” refers to a case in which, even if the coil of the fuel injection valve is energized, a valve-opening operation of the valve body is not performed and the fuel injection valve does not carry out its inherent operation. Consequently, the phrase, “non-operation waveform, which is a voltage waveform of the fuel injection valve at a time that the fuel injection valve is not operating” implies a voltage waveform that is generated in the coil when the fuel injection valve is not operated even though current is supplied to the coil of the fuel injection valve.

As noted previously, the inflection point appears in the normal operation waveform at the time of valve-closing. Therefore, an inflection point does not appear in the non-operation waveform with which the valve-opening operation is not performed. More specifically, in the case of the normal operation waveform, at the time of valve-closing, since the movable core and/or the valve body that constitute the fuel injection valve undergo movement, a change in inductance occurs, and an inflection point is generated. On the other hand, in the case of the non-operation waveform, since the movable core and/or the valve body that constitute the fuel injection valve do not undergo movement, a change in inductance does not occur, and an inflection point is not generated.

Thus, according to the present invention, the difference waveform is generated by calculating the difference between the normal operation waveform and the non-operation waveform, and the differentiated waveform is generated by differentiating the difference waveform, whereby the inflection point, which is difficult to detect from the normal operation waveform, can be detected easily using the differentiated waveform based on the difference waveform.

In the above-described control device, there may further be included a voltage reading unit configured to read in the normal operation waveform from the fuel injection valve, and a storage unit configured to store the non-operation waveform. In this case, the difference calculating unit generates the difference waveform by calculating a difference between the normal operation waveform that is read in by the voltage reading unit and the non-operation waveform that is stored in the storage unit. Owing thereto, each time that the normal operation waveform is read in, assuming the non-operation waveform is read out from the storage unit, the process to generate the difference waveform can be carried out with high efficiency.

Further, the above-described control device may include a power source that operates the fuel injection valve by energizing a coil of the fuel injection valve and thereby generating the normal operation waveform. In this case, the power source applies a voltage to the coil of a degree that does not cause operation of the fuel injection valve, each time that the fuel injection valve is operated a predetermined number of times. The voltage reading unit may read in as the normal operation waveform the voltage waveform of the coil each time that the fuel injection valve is operated, whereas the voltage waveform of the coil at a time that the fuel injection valve is not operated is read in, and the read in voltage waveform of the coil at the time that the fuel injection valve is not operated may be stored as the non-operation waveform in the storage unit.

In this manner, assuming that the non-operation waveform is read in periodically and stored in the storage unit, a most recent voltage waveform corresponding to the present condition of the fuel injection valve can be updated in the storage unit as the non-operation waveform. Consequently, each time that the fuel injection valve is operated, the difference calculating unit generates the difference waveform corresponding to the present condition of the fuel injection valve, using the normal operation waveform that is read in by the voltage reading unit, and the most recent non-operation waveform that is read out from the storage unit. As a result, assuming that the differentiated waveform is generated using the difference waveform, the operating state of the fuel injection valve can be determined with high reliability based on the differentiated waveform.

Furthermore, the fuel injection valve comprises the coil, which is magnetically excited upon being energized, a movable core, which is displaced due to energizing the coil, and a valve body, which opens or closes the fuel injection valve due to displacement of the movable core. In this case, the movable core and the valve body are constructed as separate bodies that are movable mutually relative to each other, or are constructed integrally and move together in unison. In this manner, in either case of being constructed integrally or as separate bodies, it is possible to detect the inflection point of the normal operation waveform with high accuracy, and the operating state of the fuel injection valve can be determined easily and with high reliability.

More specifically, in the case that the movable core and the valve body are constructed as separate bodies, since the velocity change at the time of valve-closing is small, although the temporal change in the inductance also is small, through application of the present invention, the inflection point of the normal operation waveform can be detected easily. On the other hand, in the case that the movable core and the valve body are constructed integrally, if the present invention is applied, the inflection point can be detected with higher reliability.

Still further, the normal operation waveform and the non-operation waveform may be waveforms in which a counter electromotive force generated in the coil of the fuel injection valve is included. In this case, since the counter electromotive force is generated in the coil, through application of the present invention, the inflection point of the normal operation waveform can be detected easily.

Moreover, the operating state determining unit may detect as an inflection point of the normal operation waveform a location of the normal operation waveform at a time that the value of the differentiated waveform is zero, and may determine the operating state of the fuel injection valve based on the detected inflection point. Owing thereto, the location of the inflection point can easily be detected.

Furthermore, the derivative calculating unit may calculate an absolute value of the differentiated waveform, and the operating state determining unit may determine the operating state of the fuel injection valve based on the absolute value of the differentiated waveform. In this case as well, the location of the inflection point can easily be detected.

More specifically, the operating state determining unit may detect as an inflection point of the normal operation waveform a location of the normal operation waveform at a time that the absolute value of the differentiated waveform is zero, and may determine the operating state of the fuel injection valve based on the detected inflection point. Owing thereto, the location of the inflection point can more easily be detected.

The above and other objects, features and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram of a control device according to an embodiment of the present invention;

FIG. 2 is a partially fragmented side view in which there is shown an example of the fuel injection valve of FIG. 1;

FIGS. 3A to 3D are explanatory diagrams of principal components in which a valve-opening operation of the fuel injection valve of FIGS. 1 and 2 is shown;

FIGS. 4A to 4D are explanatory diagrams of principal components in which a valve-closing operation of the fuel injection valve of FIGS. 1 and 2 is shown;

FIG. 5 is a timing chart showing temporal changes of various waveforms at a time of normal operation;

FIG. 6 is a timing chart showing temporal changes of various waveforms at a time of non-operation;

FIG. 7 is a timing chart showing temporal changes of a difference waveform, a differentiated waveform, and an absolute value waveform; and

FIGS. 8A to 8D are explanatory diagrams of principal components in which a valve-closing operation of an integrally constructed fuel injection valve is shown.

### DESCRIPTION OF THE PREFERRED EMBODIMENTS

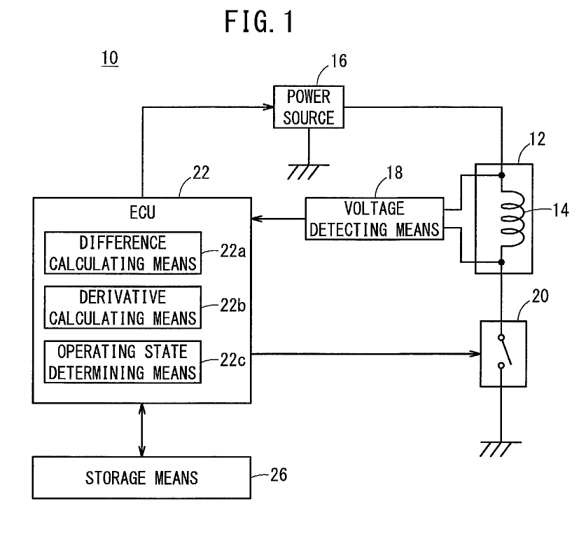

A preferred embodiment of a control device for a fuel injection valve according to the present invention will be described in detail below with reference to the accompanying drawings. In FIG. 1, reference numeral 10 indicates a control device of fuel injection valve according to an embodiment of the present invention.

As shown in FIG. 1, the control device 10 for a fuel injection valve according to the present embodiment (hereinafter referred to simply as a control device 10) includes a power source 16 that supplies current to and thereby energizes a coil 14 of a fuel injection valve 12, a voltage detecting means (unit) (voltage reading means (unit)) 18 that detects a voltage generated in the coil 14 upon being energized, a switch 20 that controls supply of current to the coil 14 by being turned on and off, and an ECU (electronic control unit) 22 that controls the power source 16 and the switch 20. The power source 16, the coil 14, and the switch 20 are constructed in the form of a serial circuit.

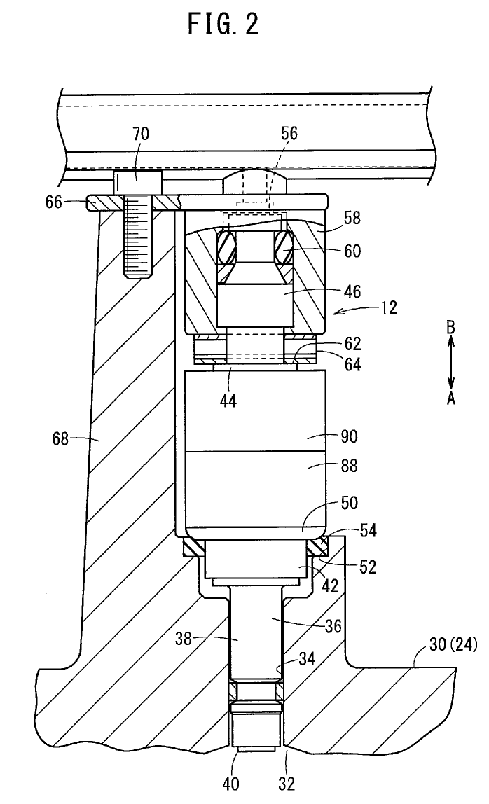

The ECU 22 serves to control operations of an engine 24 (refer to FIG. 2) that is mounted in a vehicle, and includes a difference calculating means (unit) 22a, a derivative calculating means (unit) 22b, and an operating state determining means (unit) 22c. By reading out and executing programs that are stored in a storage means (unit) 26, the ECU 22 functions as a processing means for implementing predetermined processes.

In this case, the ECU 22 supplies a command pulse to the power source 16 to instruct that current be supplied to the coil 14, while on the other hand, supplies control signals to the switch 20 for switching on or off the switch 20, which is constituted from a semiconductor switch or the like. The power source 16 is capable of supplying current to, i.e., energizing, the coil 14 only for a time duration of the pulse width of the command pulse. By turning the switch 20 on or off based on the control signals, energizing the coil 14 from the power source 16 is controlled.

Various types of voltage sensors can be applied to the voltage detecting means 18. The voltage detecting means 18 detects the voltage generated in the coil 14, and outputs the detection result to the ECU 22. More specifically, the voltage detecting means 18 reads in a voltage waveform indicative of an elapse over time of the voltage that is generated in the coil 14, and outputs the voltage waveform that is read to the ECU 22.

The difference calculating means 22a, from among the voltage waveforms input from the voltage detecting means 18, generates a difference waveform by calculating the difference between the voltage waveform (normal operation waveform) at the time that the fuel injection valve 12 is operated by energizing the coil 14, and the voltage waveform (non-operation waveform) at the time that the fuel injection valve 12 does not operate even though current is supplied to thereby energize the coil 14.

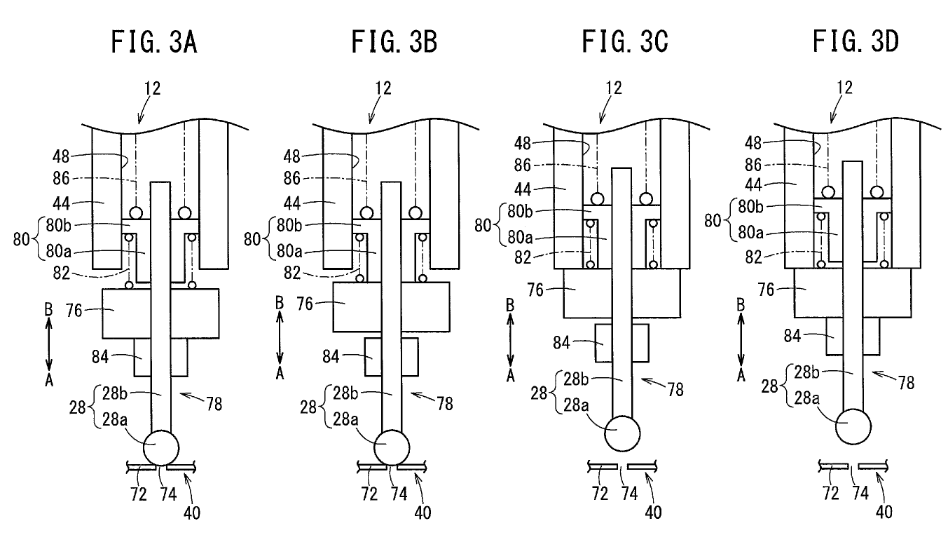

In this case, the phrase, “at a time that the fuel injection valve 12 is operated” refers to a case in which, due to energizing the coil 14 of the fuel injection valve 12, a later-described valve body 28 (see FIG. 3A) is placed in a valve-open or a valve-closed condition, whereby the fuel injection valve 12 carries out its inherent operation (i.e., an operation to inject fuel). Consequently, the phrase, “normal operation waveform” implies a voltage waveform that is generated in the coil 14 when the fuel injection valve 12 is operated by supplying current to the coil 14 of the fuel injection valve 12.

Further, the phrase, “at a time that the fuel injection valve 12 does not operate” refers to a case in which, even if the coil 14 of the fuel injection valve 12 is energized, a valve-opening operation of the valve body 28 is not performed and the fuel injection valve 12 does not carry out its inherent operation. Consequently, the phrase, “non-operation waveform” implies a voltage waveform that is generated in the coil 14 when the fuel injection valve 12 is not operated even though current is supplied to the coil 14 of the fuel injection valve 12.

The non-operation waveform is stored beforehand in the storage means 26. Therefore, each time that the normal operation waveform is input thereto from the voltage detecting means 18, the difference calculating means 22a reads out the non-operation waveform stored in the storage means 26, and calculates a difference waveform using the normal operation waveform and the non-operation waveform that have been read out.

The derivative calculating means 22b generates a differentiated waveform obtained by differentiating with respect to time the difference waveform generated by the difference calculating means 22a. The operating state determining means 22c determines the operating state of the fuel injection valve 12 based on the differentiated waveform generated by the derivative calculating means 22b.

As noted previously, the fuel injection valve 12 is operated due to supplying a command pulse to the power source 16 from the ECU 22. Therefore, in the case that an operation of the fuel injection valve 12 due to a one time command pulse is considered as one time portion, in the control device 10, each time that a command pulse is supplied from the ECU 22 to the power source 16, the voltage detecting means 18 reads in the normal operation waveform and outputs the normal operation waveform to the ECU 22. Consequently, within the ECU 22, the difference calculating means 22a, the derivative calculating means 22b, and the operating state determining means 22c execute the above-described respective processes each time that the normal operation waveform is input from the voltage detecting means 18.

Furthermore, in the control device 10, each time that the fuel injection valve 12 is operated a predetermined number of times, a command pulse for applying to the coil 14 from the power source 16 a voltage of such a degree that does not cause operation of the fuel injection valve 12 is supplied to the power source 16 from the ECU 22. Owing thereto, since the fuel injection valve 12 does not perform its inherent operation, the voltage detecting means 18 outputs to the ECU 22 as a non-operation waveform the voltage waveform of the coil 14 that has been read in therefrom. Consequently, the ECU 22 is capable of storing in the storage means 26 and updating the most recently input non-operation waveform.

Details of the processing content of the respective means implemented within the ECU 22 will be described later.

FIG. 2 is a partially fragmented side view in which there is shown an example of the fuel injection valve 12. Note that the control device 10 is not limited to being applied to the fuel injection valve 12 of FIG. 2, and can be applied to controlling various other types of fuel injection valves.

A mounting hole 34 that opens into a combustion chamber 32 is provided in a cylinder head 30 of the engine 24, and the fuel injection valve 12 is arranged in the mounting hole 34. As a result, the fuel injection valve 12 is capable of injecting fuel into the combustion chamber 32. As will be described below, on the fuel injection valve 12, the fuel injection side thereof will be described as a distal end side (in the direction of the arrow A), and the fuel inflow side thereof will be described as a proximal end side (in the direction of the arrow B).

The fuel injection valve 12 is equipped with a valve housing 36. The valve housing 36 is constituted from a valve housing body 38 of a hollow cylindrical shape, a bottomed cylindrical valve seat member 40 that is fitted and welded to an inner circumferential surface of a distal end side of the valve housing body 38, a magnetic cylindrical body 42 that is fitted and welded to a large diameter portion of a proximal end side of the valve housing body 38, and a non-magnetic cylindrical body (not shown) that is coupled coaxially with the proximal end side of the magnetic cylindrical body 42. A fixed core 44 (see FIGS. 2 and 3A) is coupled coaxially with the proximal end side of the non-magnetic cylindrical body, and a fuel inlet tube 46 is consecutively arranged coaxially and integrally with the proximal end side of the fixed core 44. The fixed core 44 includes a hollow portion 48 in communication with the interior of the fuel inlet tube 46.

The magnetic cylindrical body 42 includes in an integral manner a flange shaped yoke 50 provided in an axial intermediate portion thereof. The yoke 50 is supported through a cushion member 54 in a load receiving hole 52 that surrounds an upper end opening of the mounting hole 34 of the cylinder head 30. A fuel filter 56 is mounted in an inlet opening of the fuel inlet tube 46, and a fuel delivery pipe 58 for delivering fuel at high pressure is fitted via a sealing member 60 on the outer circumference of the fuel inlet tube 46.

An elastic retaining member 64 made up from a plate spring is interposed between the fuel delivery pipe 58 and a rear end surface 62 of the fixed core 44. A bracket 66 of the fuel delivery pipe 58 is fixed by a bolt 70 with respect to a support column 68 of the cylinder head 30, whereby a predetermined set load (compression load) is applied to the elastic retaining member 64. As a result, by being gripped between the cylinder head 30 and the elastic retaining member 64 with the set load of the elastic retaining member 64, the fuel injection valve 12 is capable of withstanding the high pressure of the combustion chamber 32 of the engine 24.

As shown in the explanatory diagram of FIG. 3A, in which there are shown principal components of the interior of the fuel injection valve 12, the valve seat member 40 includes a valve seat 72, and a fuel injection hole 74 opens in the vicinity of the center of the valve seat 72.

A valve assembly 78, which is made up from the valve body 28 and the movable core 76, is accommodated in the interior of the valve housing 36 (see FIG. 2) extending from the valve seat member 40 up to the non-magnetic cylindrical body. The valve body 28 is constituted by a spherical valve member 28a that opens and closes the fuel injection hole 74 in cooperation with the valve seat 72, and a valve needle 28b that supports the valve member 28a and extends up to the hollow portion 48 of the fixed core 44. The valve member 28a is formed in a spherical shape so as to be supported slidably on the inner circumferential surface of the valve seat member 40.

The movable core 76 is a cylindrical member provided on the outer circumferential surface of the valve needle 28b, and is constructed separately from the valve needle 28b. In this case, the upper surface of the movable core 76 is formed with a size that is capable of abutment on a distal end surface of the fixed core 44. Further, the movable core 76 and the valve needle 28b are disposed to be movable mutually with respect to each other along the direction of the arrow A and the direction of the arrow B.

On the valve needle 28b at a location upwardly of the movable core 76, a guide member 80 that is fitted slidably with respect to the hollow portion 48 of the fixed core 44 is press-fitted over and is fixedly welded to the valve needle 28b. Consequently, the valve needle 28b and the guide member 80 are constructed together in an integral manner. The guide member 80 is constituted from a cylindrical shaft section 80a into which the valve needle 28b is press-fitted, and a flange section 80b that projects out diametrically from the proximal end of the cylindrical shaft section 80a and is fitted slidably in the hollow portion 48. A spring member 82 is interposed between the flange section 80b and an upper surface of the movable core 76.

On the other hand, a stopper 84 is fixedly secured to the valve needle 28b at a location below the movable core 76. Consequently, the stopper 84 is constructed integrally with the valve needle 28b. In this case, the upper surface of the stopper 84 is formed with a size that is capable of abutment on a bottom surface of the movable core 76.

Furthermore, in the hollow portion 48, a valve spring 86, which urges the flange section 80b of the guide member 80 toward a valve-closing side of the valve body 28, is arranged in a compressed state.

A coil assembly, which includes the coil 14 (see FIG. 1) on an outer circumferential surface thereof from a proximal end portion of the magnetic cylindrical body 42 and reaching to the fixed core 44, is fitted into the fuel injection valve 12. The coil assembly is made up from a bobbin and the coil 14 that is wound around a bobbin, and the coil assembly is accommodated in the interior of the coil housing 88 (see FIG. 2).

A synthetic resin covering layer 90 which covers the outer circumferential surface is formed by molding from a proximal end part of the coil housing 88 to a proximal end part of the fixed core 44. A non-illustrated coupler that projects out toward one side of the fixed core 44 is connected integrally to the covering layer 90, and terminals connected to the coil 14 are retained by the coupler. The terminals are connected electrically to the power source 16.

The control device 10 and the fuel injection valve 12 according to the present embodiment are configured basically as described above. Next, operations of the control device 10 will be described with reference to FIGS. 3A through 7.

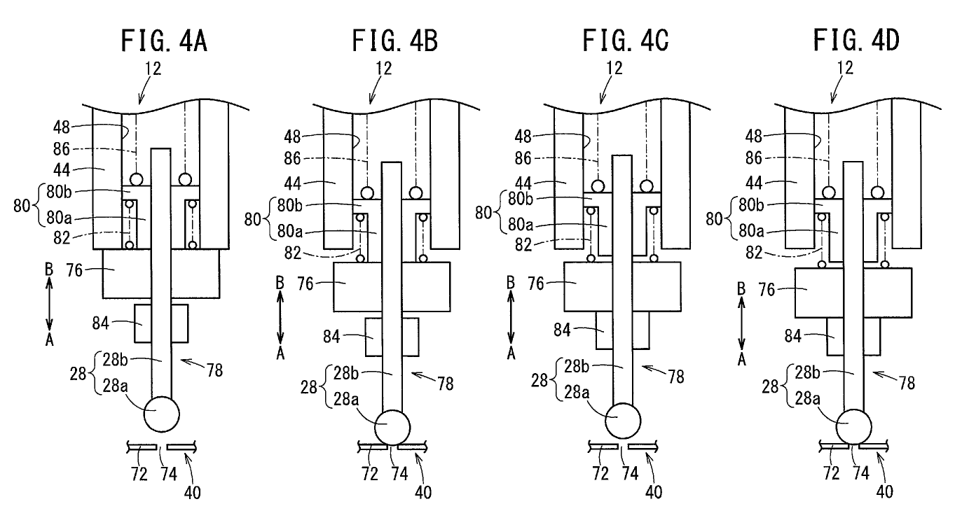

Concerning respective operations at the time of valve-opening and at the time of valve-closing of the fuel injection valve 12, descriptions thereof will be made with reference to FIGS. 3A through 5. Next, operations of the control device 10 at a time of valve-closing of the fuel injection valve 12 will be described with reference to FIGS. 4A through 7. Further, within these descriptions, reference may also be made to FIGS. 1 and 2 as necessary.

FIGS. 3A to 3D are explanatory diagrams of principal components in which a valve-opening operation of the fuel injection valve 12 is shown.

In the valve-closed state of FIG. 3A, by urging the valve spring 86 in the direction of the arrow A, the integral construction of the valve body 28 and the guide member 80 is pressed against the valve seat member 40, and the valve member 28a closes and blocks the fuel injection hole 74. By the guide member 80 being pressed in the direction of the arrow A, the spring member 82 presses the movable core 76 in the direction of the arrow A. As a result, the movable core 76 comes into abutment against the stopper 84.

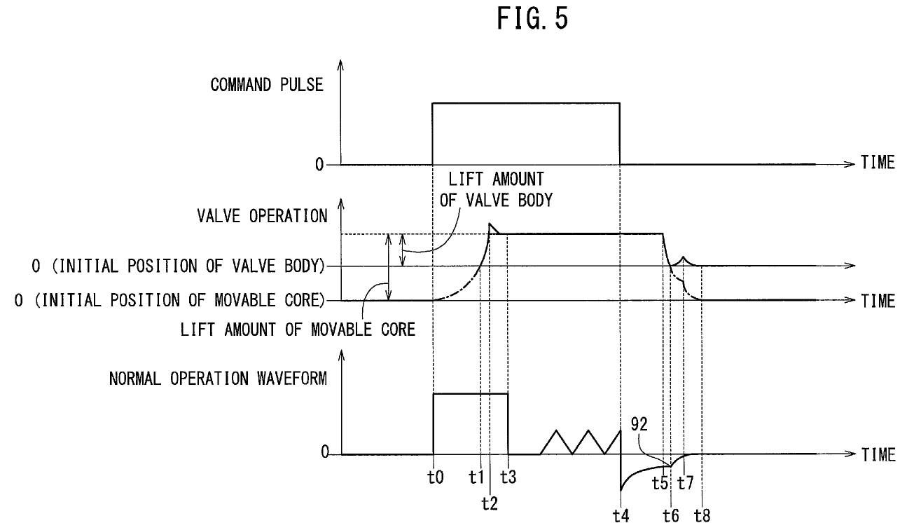

Then, at time t0 in FIG. 5, the ECU 22 (see FIG. 1) supplies a command pulse to the power source 16, and in addition supplies a control signal to the switch 20. Accordingly, in a time zone from time t0 to time t3, the switch 20 is turned on and the power source 16 is capable of energizing the coil 14 in accordance with the command pulse. As a result, the coil 14 is excited, and a magnetic path is formed in the fixed core 44 and the movable core 76.

As noted previously, since the valve body 28 and the movable core 76 are constructed separately, due to formation of the magnetic path, as a result of a pulling force in the direction of the arrow B that is generated in the movable core 76, as shown in FIG. 3B, the movable core 76 rises upwardly in the direction of the arrow B in opposition to the pressing force in the direction of the arrow A of the spring member 82. As shown by the one dot dashed line within the graph labeled “valve operation” in FIG. 5, accompanying an elapse of time from time to, the movable core 76 rises upwardly. As a result, the movable core 76 collides against the distal end surface of the cylindrical shaft section 80a of the guide member 80. Moreover, in FIG. 5, the character “0” located downwardly in the “valve operation” graph indicates an initial position of the movable core 76 (position of the movable core 76 at time t0). Further, the character “0” located upwardly in the “valve operation” graph indicates an initial position of the valve body 28 (position of the valve body 28 from time t0 to time t1), while in addition, indicates a position at which the upper surface of the movable core 76 collides against the distal end surface of the cylindrical shaft section 80a. Consequently, in the “valve operation” waveform, the positions indicated by the characters “0” imply respective starts of operation of the movable core 76 and the valve body 28 from the initial positions thereof.

After the movable core 76 has collided against the distal end surface of the cylindrical shaft section 80a of the guide member 80, the movable core 76 rises further in the direction of the arrow B in opposition to the pressing force of the spring member 82. Owing thereto, the guide member 80, which is in abutment against the movable core 76, also rises together with the integral structure of the valve body 28 in the direction of the arrow B in opposition to the pressing force in the direction of the arrow A of the valve spring 86. As a result, as shown in FIG. 3C, the valve member 28a separates from the valve seat 72, the fuel injection hole 74 opens, and the upper surface of the movable core 76 collides against the distal end surface of the fixed core 44.

As shown by the solid line within the graph labeled “valve operation” in FIG. 5, together with the movable core 76, the valve body 28 rises along with the elapse of time from its initial position indicated by the upwardly located character “0”. As a result, the fuel injection valve 12 transitions from a valve-closed state to a valve-open state, making it possible for fuel to be injected into the combustion chamber 32 from the fuel injection hole 74. The dashed line within the graph labeled “valve operation” in FIG. 5 indicates a threshold value used for determining whether or not the fuel injection valve 12 is in a valve-open state. More specifically, when the position of the dashed line is reached, it can be determined that the fuel injection valve 12 has transitioned to the valve-open state.

As described above, even though the movable core 76 collides against the fixed core 44, the valve body 28 is not stopped immediately, but by the inertial force thereof, rises to a position at which, as shown in FIG. 3D, the upper surface of the stopper 84 collides with the bottom surface of the movable core 76, or stated otherwise, rises to an overshoot position as indicated at time t2 in FIG. 5.

Thereafter, due to the biasing force in the direction of the arrow A of the valve spring 86, the valve body 28 descends to the position shown in FIGS. 3C and 4A. Consequently, at this time, the valve-opening operation of the fuel injection valve 12 is completed. The spacing from the position of the downwardly located character “0” in FIG. 5 to the position of the dashed line is representative of a lift amount of the movable core 76, whereas the spacing from the position of the upwardly located character “0” to the position of the dashed line is representative of a lift amount of the valve body 28.

After valve-opening of the fuel injection valve 12, at time t3, when the switch 20 is switched from on to off by control of the ECU 22, supplying of current to the coil 14 from the power source 16 is stopped temporarily. Thereafter, in a time zone from time t3 to time t4, the ECU 22 repeatedly turns the switch 20 on or off, whereby a hold period is established in which energizing of the coil 14 is intermittently carried out. In the hold period, the voltage applied to the coil 14, due to the repeated turning on or off of the switch 20, becomes a lower level voltage which is lower than that during the time zone from time t0 to time t3. More specifically, the low level voltage, which moves periodically up and down with respect to the passage of time, is applied repeatedly to the coil 14. As a result, the valve-open state of the fuel injection valve 12 can be held with a smaller current (consumed power).

The description given above concerns the valve-opening operation. Next, with reference to the explanatory diagrams of principal components shown in FIGS. 4A through 4D, a description will be given concerning a valve-closing operation.

While the valve-open state is being held as shown in FIG. 4A, at time t4 in FIG. 5, when supply of current to the coil 14 from the power source 16 is stopped, a counter electromotive force is generated in the normal operation waveform of the coil 14. The counter electromotive force reaches a negative peak value at time t4, and thereafter, the negative value thereof decreases with the elapse of time, reaching a value of 0 V at time t8.

On the other hand, the valve body 28, etc., does not undergo the valve-closing operation immediately, even though energizing is halted at time t4, but rather, the valve-closing operation is started from time t5. More specifically, at time t5, the flange section 80b of the guide member 80 is pressed by the biasing force in the direction of the arrow A of the valve spring 86, whereupon the valve body 28 and the stopper 84, which are integrally made with the guide member 80, descend in the direction of the arrow A.

In this case, since the distal end surface of the cylindrical shaft section 80a of the guide member 80 abuts against the upper surface of the movable core 76, and the spring member 82 biases the movable core 76 in the direction of the arrow A, as shown within the graph labeled “valve operation” in FIG. 5, the movable core 76 and the valve body 28 descend together in the direction of the arrow A at the same speed of movement. As a result, as shown in FIG. 4B, the valve member 28a collides with the valve seat 72 at time t6, and the fuel injection hole 74 is closed temporarily. At this time, in the voltage waveform, an inflection point 92 is generated with respect to the counter electromotive force.

The inflection point 92, which occurs at time t6, is generated by a temporal change in inductance, which is caused by the valve body 28 being seated on the valve seat 72, together with the movable core 76 continuing to descend in the direction of the arrow A. More specifically, the inductance changes over time by the occurrence of a difference in speed between the valve body 28 and the movable core 76 due to a weight difference between the valve body 28 and the movable core 76, as well as a difference in the biasing force of the spring member 82 and the valve spring 86.

In addition, as shown in FIG. 4C, from time t6 to time t7, the valve body 28 including the valve member 28a that has collided with the valve seat 72, the guide member 80, and the stopper 84 bounce back in the direction of the arrow B in opposition to the biasing force of the valve spring 86. On the other hand, since the movable core 76 and the valve body 28 are constructed separately, the movable core 76 continues to descend according to the principle of inertia at the movement speed it had when it was lowered integrally with the valve body 28, etc. As a result, at time t7, the lower surface of the movable core 76 collides against the upper surface of the stopper 84.

Thereafter, from time t7 to time t8, by the biasing force in the direction of the arrow A of the valve spring 86, the valve body 28, the movable core 76, the guide member 80, and the stopper 84 are lowered integrally, whereby at time t8, the valve member 28a abuts against the valve seat 72 and the fuel injection hole 74 is closed. Consequently, the valve-closing operation of the fuel injection valve 12 is completed.

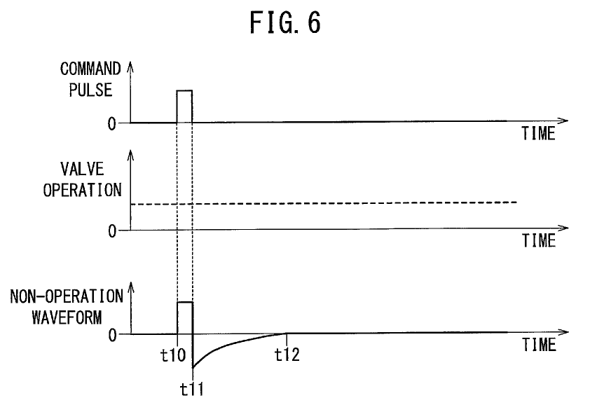

The description given above concerns the valve-closing operation. Next, with reference to FIG. 6, a description will be given concerning the non-operation waveform.

The non-operation waveform is generated due to a short time command pulse from time t10 to time t11 being supplied to the power source 16 from the ECU 22. More specifically, only during the short time period from time t10 to time t11, the switch 20 is turned on, and the power source 16 energizes the coil 14. If energizing (application of voltage) is performed for such a short time period, since the fuel injection valve 12 does not transition from the valve-closed state to the valve-open state, the inherent operation of the fuel injection valve 12 is not performed. On the other hand, when energizing of the coil 14 is stopped at time t11, a counter electromotive force is generated in the time zone from time t11 to time t12. As noted previously, since the inherent operation of the fuel injection valve 12 is not carried out, an inflection point 92 is not generated in the counter electromotive force. More specifically, in the case of the non-operation waveform, since the valve-closing operation is not performed, the movable core 76, etc., does not undergo movement, and there is no temporal change in the inductance.

Consequently, in the case that the inherent operation of the fuel injection valve 12 is performed, the voltage detecting means 18 reads in the normal operation waveform of FIG. 5 and outputs it to the ECU 22, whereas, in the case that the inherent operation of the fuel injection valve 12 is not performed, the voltage detecting means 18 reads in the non-operation waveform of FIG. 6 and outputs it to the ECU 22. The control device 10 may acquire the non-operation waveform each time that the fuel injection valve 12 is operated a predetermined number of times (for example, every 100 times or every 1000 times).

When carried out in this manner, in the case that the voltage waveform (normal operation waveform, non-operation waveform) is output from the voltage detecting means 18 to the ECU 22, the following process is executed in the ECU 22.

More specifically, when the non-operation waveform is input to the ECU 22 from the voltage detecting means 18, the ECU 22 stores the non-operation waveform in the storage means 26. Owing thereto, the non-operation waveform that is stored in the storage means 26 is updated to the most recent non-operation waveform.

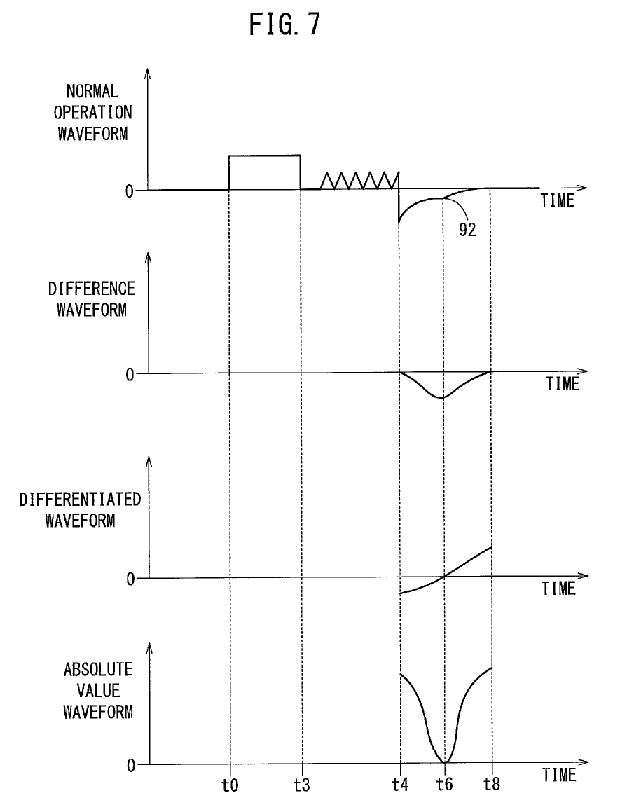

On the other hand, in the case that the normal operation waveform of FIG. 7 is input to the ECU 22 from the voltage detecting means 18, the difference calculating means 22a of the ECU 22 reads out the non-operation waveform from the storage means 26, calculates the difference between the non-operation waveform that was read out and the normal operation waveform, and generates the difference waveform.

The difference waveform of FIG. 7 is a negative voltage waveform having a peak value at time t6. This is because, at time t6, the inflection point 92 is generated only in the normal operation waveform, and at time t4 and time t8, respectively, counter electromotive forces of the same value are generated in the normal operation waveform and the non-operation waveform. As a result, the voltage level of the difference waveform becomes zero at time t4 and at time t8.

Next, the derivative calculating means 22b generates a differentiated waveform obtained by differentiating with respect to time the difference waveform that was generated by the difference calculating means 22a. The differentiated waveform of FIG. 7 is a waveform having a value of zero at time t6. Further, the derivative calculating means 22b is capable of generating an absolute value waveform by calculating the absolute value of the differentiated waveform. The absolute value waveform of FIG. 7 is a waveform that descends to zero at time t6.

Next, the operating state determining means 22c determines the operating state of the fuel injection valve 12 based on the differentiated waveform and/or the absolute value waveform calculated by the derivative calculating means 22b. More specifically, the operating state determining means 22c detects the point in time when the value of the differentiated waveform becomes zero and/or that the value of the absolute value waveform becomes zero (at time t6 in FIG. 7), and detects the detected time t6 as the point in time at which the inflection point 92 appears in the normal operation waveform. Consequently, based on the detected time t6 of the inflection point 92, for example, the operating state determining means 22c is capable of determining a delay or the like in the valve-closing time of the fuel injection valve 12, and can carry out an appropriate control with respect to the fuel injection valve 12.

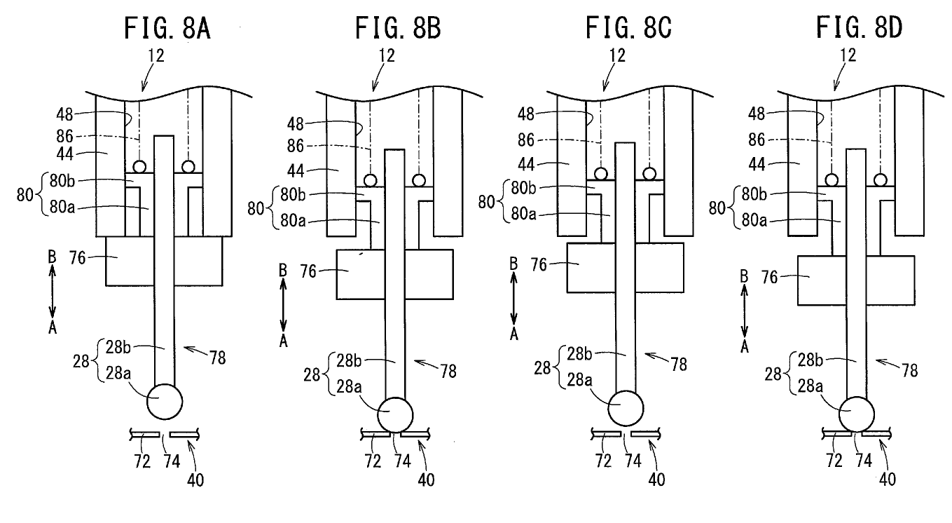

In the above explanation, although a description has been made concerning a case in which the valve body 28 and the movable core 76 are constructed separately, the control device 10 according to the present embodiment can also be applied to a case in which the valve body 28 and the movable core 76 are constructed integrally, as shown in FIGS. 8A through 8D. It should be noted that, in the case of such an integral structure, the spring member 82 and the stopper 84 are omitted.

In describing the valve-closing operation in the integral structure, at first, at the time of the valve-open state as shown in FIG. 8A, when energizing of the coil 14 from the power source 16 is stopped, a counter electromotive force is generated in the coil 14. More specifically, when the guide member 80 is pressed by the biasing force in the direction of the arrow A of the valve spring 86, the valve body 28 and the movable core 76 which are integrally constructed with the guide member 80 descend in the direction of the arrow A. As a result, as shown in FIG. 8B, the valve member 28a collides with the valve seat 72, and the fuel injection hole 74 is closed temporarily. In this case as well, in the voltage waveform, an inflection point 92 is generated with respect to the counter electromotive force.

Thereafter, the valve body 28 including the valve member 28a that has collided with the valve seat 72, the movable core 76, and the guide member 80 bounce back in the direction of the arrow B in opposition to the biasing force of the valve spring 86. Next, by the biasing force in the direction of the arrow A of the valve spring 86, the valve body 28, the movable core 76, and the guide member 80 are lowered integrally, whereby the valve member 28a abuts against the valve seat 72, and the fuel injection hole 74 is closed. Consequently, the valve-closing operation of the fuel injection valve 12 is completed.

Even in the case of such an integral structure, the ECU 22 is capable of detecting the inflection point 92 using the normal operation waveform and the non-operation waveform. Further, in the case of the integral structure, since the velocity change of the movable core 76 at the time of valve-closing becomes greater than in the case of the separated structure shown in FIGS. 4A through 4D, the change in inductance becomes large, and the inflection point 92 appears prominently. Therefore, the inflection point 92 can easily be detected with the ECU 22.

As has been described above, in accordance with the control device 10 according to the present embodiment, the difference calculating means 22a of the ECU 22 calculates the difference between the normal operation waveform and the non-operation waveform, and generates the difference waveform. Next, the derivative calculating means 22b generates the differentiated waveform by differentiating with respect to time the difference waveform. Lastly, the operating state determining means 22c determines the operating state of the fuel injection valve 12 based on the differentiated waveform. More specifically, with the present embodiment, the differentiated waveform is generated by differentiating with respect to time the difference waveform, and without simply differentiating the normal operation waveform as in Japanese Laid-Open Patent Publication No. 2001-280189.

Consequently, even if a temporal change of the inductance at the time of valve-closing of the fuel injection valve 12 is small, and it is difficult to detect the inflection point 92 from the normal operation waveform, by using the differentiated waveform obtained from the difference waveform, the inflection point 92 of the normal operation waveform can be detected. As a result, even if various different situations of the fuel injection valve 12 are present, the operating state of the fuel injection valve 12 can be determined with high reliability and accuracy. Accordingly, with the present embodiment, based on the highly precise determination result, the fuel injection valve 12 can be controlled appropriately, and the injection performance of the fuel injection valve 12 can be enhanced.

In this case, the inflection point 92 appears in the normal operation waveform at the time of valve-closing. Therefore, an inflection point 92 does not appear in the non-operation waveform with which the valve-opening and valve-closing operations are not performed. More specifically, in the case of the normal operation waveform, at the time of valve-closing, since the movable core 76 and/or the valve body 28 that constitute the fuel injection valve 12 undergo movement, a change in inductance occurs, and the inflection point 92 is generated. On the other hand, in the case of the non-operation waveform, since the movable core 76 and/or the valve body 28 do not undergo movement, a change in inductance does not occur, and the inflection point 92 is not generated.

Thus, according to the present embodiment, the difference waveform is generated by calculating the difference between the normal operation waveform and the non-operation waveform, and the differentiated waveform is generated by differentiating over time the difference waveform, whereby the inflection point 92, which is difficult to detect from the normal operation waveform, can be detected easily using the differentiated waveform based on the difference waveform.

Further, in the control device 10, there is further included the voltage detecting means 18 for reading in the normal operation waveform from the coil 14 of the fuel injection valve 12, and the storage means 26 in which the non-operation waveform is stored. Owing thereto, the difference calculating means 22a generates the difference waveform by calculating the difference between the normal operation waveform, which is read in by the voltage detecting means 18, and the non-operation waveform that is stored in the storage means 26. As a result, each time that the normal operation waveform is read in, assuming the non-operation waveform is read out from the storage means 26, the process to generate the difference waveform can be carried out with high efficiency.

Further, the control device 10 includes the power source 16 that operates the fuel injection valve 12 by energizing the coil 14 of the fuel injection valve 12 and thereby generating the normal operation waveform. In this case, the power source 16 applies a voltage to the coil 14 of a degree that does not cause operation of the fuel injection valve 12, each time that the fuel injection valve 12 is operated a predetermined number of times. The voltage detecting means 18 reads in as the normal operation waveform the voltage waveform of the coil 14 each time that the fuel injection valve 12 is operated, whereas the voltage waveform of the coil 14 at a time that the fuel injection valve 12 is not operated is read in, and the read-in voltage waveform of the coil 14 at the time that the fuel injection valve 12 is not operated is stored as the non-operation waveform in the storage means 26 via the ECU 22.

In this manner, assuming that the non-operation waveform is read in periodically and stored in the storage means 26, a most recent voltage waveform corresponding to the present condition of the fuel injection valve 12 can be updated in the storage means 26 as the non-operation waveform. Consequently, each time that the fuel injection valve 12 is operated, the difference calculating means 22a is capable of generating the difference waveform corresponding to the present condition of the fuel injection valve 12, using the normal operation waveform that is read in by the voltage detecting means 18, and the most recent non-operation waveform that is read out from the storage means 26. As a result, assuming that the differentiated waveform is generated using the difference waveform, the operating state of the fuel injection valve 12 can be determined with high reliability and accuracy based on the differentiated waveform.

Furthermore, the fuel injection valve 12 comprises the coil 14, which is magnetically excited upon being energized, the movable core 76, which is displaced due to energizing the coil 14, and the valve body 28, which opens or closes the fuel injection valve due to displacement of the movable core 76. In this case, the movable core 76 and the valve body 28 are constructed as separate bodies that are movable mutually relative to each other, or are constructed integrally and move together in unison. In this manner, in either case of being constructed integrally or as separate bodies, it is possible to detect the inflection point 92 of the normal operation waveform with high accuracy, and the operating state of the fuel injection valve 12 can be determined easily and with high reliability.

More specifically, in the case that the movable core 76 and the valve body 28 are constructed as separate bodies, since the velocity change at the time of valve-closing is small and the temporal change in the inductance also is small, through application of the present embodiment, the inflection point 92 of the normal operation waveform can be detected easily. On the other hand, in the case that the movable core 76 and the valve body 28 are constructed integrally, if the present embodiment is applied, the inflection point 92 can be detected with higher reliability.

Still further, the normal operation waveform and the non-operation waveform may be waveforms in which a counter electromotive force generated in the coil 14 of the fuel injection valve 12 is included. At the time of valve-closing, since the counter electromotive force is generated in the coil 14, through application of the present embodiment, the inflection point 92 of the normal operation waveform can be detected easily.

Further, the operating state determining means 22c detects as the time at which the inflection point 92 is generated the time t6 of the normal operation waveform when the value of the differentiated waveform is zero, and determines the operating state of the fuel injection valve 12 based on the detected inflection point 92. Owing thereto, the location of the inflection point 92 can easily be detected.

Furthermore, the derivative calculating means 22b may calculate an absolute value (absolute value waveform) of the differentiated waveform, and the operating state determining means 22c may determine the operating state of the fuel injection valve 12 based on the absolute value waveform. In this case as well, the location of the inflection point 92 can easily be detected.

More specifically, the operating state determining means 22c may detect as the time of the inflection point 92 of the normal operation waveform the time t6 of the normal operation waveform when the value of the absolute value of the differentiated waveform is zero, and may determine the operating state of the fuel injection valve 12 based on the detected inflection point 92. Owing thereto, the time of the inflection point 92 can more easily be detected.

The control device for a fuel injection valve according to the present invention is not limited to the embodiment described above, and various additional or modified configurations may be adopted therein without deviating from the essence of the present invention.

What is claimed is:

1. A control device for a fuel injection valve that determines an operating state of the fuel injection valve, and controls the fuel injection valve based on a determination result thereof, comprising:
a difference calculating unit configured to generate a difference waveform composed of the difference between a normal operation waveform, which is a voltage waveform of the fuel injection valve at a time that the fuel injection valve is operating, and a non-operation waveform, which is a voltage waveform of the fuel injection valve at a time that the fuel injection valve is not operating;
a derivative calculating unit configured to generate a differentiated waveform obtained by differentiating the difference waveform; and
an operating state determining unit configured to determine the operating state of the fuel injection valve based on the differentiated waveform.

2. The control device for a fuel injection valve according to claim 1, further comprising:
a voltage reading unit configured to read in the normal operation waveform from the fuel injection valve; and
a storage unit configured to store the non-operation waveform;
wherein the difference calculating unit generates the difference waveform by calculating a difference between the normal operation waveform that is read in by the voltage reading unit and the non-operation waveform that is stored in the storage unit.

3. The control device for a fuel injection valve according to claim 2, further comprising:
a power source that operates the fuel injection valve by energizing a coil of the fuel injection valve and thereby generating the normal operation waveform;
wherein the power source applies a voltage to the coil of a degree that does not cause operation of the fuel injection valve, each time that the fuel injection valve is operated a predetermined number of times; and
the voltage reading unit reads in as the normal operation waveform the voltage waveform of the coil each time that the fuel injection valve is operated, whereas the voltage waveform of the coil at a time that the fuel injection valve is not operated is read in, and the read in voltage waveform of the coil at the time that the fuel injection valve is not operated is stored as the non-operation waveform in the storage unit.

4. The control device for a fuel injection valve according to claim 1, wherein:
the fuel injection valve comprises the coil, which is magnetically excited upon being energized, a movable core, which is displaced due to energizing of the coil, and a valve body, which opens or closes the fuel injection valve due to displacement of the movable core;
wherein the movable core and the valve body are constructed as separate bodies that are movable mutually relative to each other, or are constructed integrally and move together in unison.

5. The control device for a fuel injection valve according to claim 1, wherein the normal operation waveform and the non-operation waveform are waveforms in which a counter electromotive force generated in the coil of the fuel injection valve is included.

6. The control device for a fuel injection valve according to claim 1, wherein the operating state determining unit detects as an inflection point of the normal operation waveform a location of the normal operation waveform at a time that the value of the differentiated waveform is zero, and determines the operating state of the fuel injection valve based on the detected inflection point.

7. The control device for a fuel injection valve according to claim 1, wherein:
the derivative calculating unit calculates an absolute value of the differentiated waveform; and
the operating state determining unit determines the operating state of the fuel injection valve based on the absolute value of the differentiated waveform.

8. The control device for a fuel injection valve according to claim 7, wherein the operating state determining unit detects as an inflection point of the normal operation waveform a location of the normal operation waveform at a time that the absolute value of the differentiated waveform is zero, and determines the operating state of the fuel injection valve based on the detected inflection point.
